(19) United States
(12) Patent Application Publication
(10) Pub. No.: US 2003/0070259 A1
(43) Pub. Date: Apr. 17, 2003

(54) Elastomeric grips for personal care products

(76) Inventors: William R. Brown, Peabody, MA (US); Helge Zimmet, Waltham, MA (US)

Correspondence Address: FISH & RICHARDSON PC, 225 FRANKLIN ST, BOSTON, MA, 02110, US

(21) Appl. No.: 09/977,629

(22) Filed: Oct. 15, 2001

(51) Int. Cl. E05B 1/00

(52) U.S. Cl. 16/436

(57) ABSTRACT

Personal care products are provided having grips with a sheath/core construction. Methods are provided for manufacturing such grips.

### TECHNICAL FIELD

This invention relates to grips for handles of personal care products, and more particularly to grips for toothbrush and razor handles.

### BACKGROUND

Overmolding elastomeric grips onto personal care products is well known in the art. For example, U.S. Pat. No. 6,108,869 describes overmolding elastomeric grips onto a toothbrush handle for comfort and tactile properties.

The elastomeric material should generally be of a sufficient hardness to provide abrasion resistance. Also, the elastomeric material should generally be sufficiently hard so that it will bond to the substrate handle. Very soft elastomeric materials tend to be too oily to properly bond to the substrate handle.

To provide compliance and user comfort with a relatively hard elastomeric material, the elastomeric grip must be relatively thick. The underlying handle generally must be sufficiently thick to provide rigidity. This becomes particularly problematic on smaller handles, such as children's toothbrush handles, which require as much substrate material as possible to maintain rigidity. At the same time, the total diameter of the finished handle cannot be so large that the handle becomes awkward to grip. Thus, generally the thicker the substrate handle must be, the thinner the grip. Therefore, a compromise must often be made between rigidity and user comfort.

### SUMMARY

The invention features grips for personal care products that include a relatively harder sheath elastomeric material over a relatively softer core elastomeric material. The sheath material provides the desired abrasion resistance, tactile characteristics and adhesion to the underlying handle. The core material provides the desired compliance. Therefore, the grip can be thinner because an overall softer grip is achieved with less material than would be required if the grip were formed with a single elastomeric material. As a result, for a given handle diameter the substrate handle can be thicker to provide rigidity. By combining two materials in one part in a sheath-core combination, it is possible to create a part with properties that one material alone cannot achieve.

Personal care products are products used in personal hygiene and grooming. For example, toothbrushes, razors and hairbrushes.

In one aspect, the invention featured a method of manufacturing a personal care product that includes applying a grip to a handle of a personal care product, in which the grip comprises a core and a sheath surrounding the core, where the sheath has a hardness greater than the core.

Preferred embodiments may include one or more of the following features. The core is an elastomeric material. The elastomeric material is a thermoplastic elastomer. The thermoplastic elastomer of the core can be thermoplastic vulcanates (rubber polyolefin blends), polyetheramides, polyesters, styrene-ethylene-butylene-styrene (SEBS) block copolymers, styrene-butadiene-styrene (SBS) block copolymers, partially or fully hydrogenated styrene-butadiene-styrene block copolymers, styrene-isoprene-styrene block copolymers, polyurethanes, polyolefin elastomers, polyolefin plastomers, styrenic based polyolefin elastomers, or compatible mixtures thereof. The core hardness is preferably less than 50 Shore A, more preferably less than 25 Shore A, and most preferably less than 10 Shore A. The sheath is an elastomeric material. The elastomeric material is a thermoplastic elastomer. The thermoplastic elastomer of the sheath can be thermoplastic vulcanates (rubber polyolefin blends), polyetheramides, polyesters, styrene-ethylene-butylene-styrene (SEBS) block copolymers, styrene-butadiene-styrene (SBS) block copolymers, partially or fully hydrogenated styrene-butadiene-styrene block copolymers, styrene-isoprene-styrene block copolymers, polyurethanes, polyolefin elastomers, polyolefin plastomers, styrenic based polyolefin elastomers, or compatible mixtures thereof. The sheath has a thickness of preferably 0.4 to 4.0 mm thick, more preferably 0.5 to 2.0 mm thick, and most preferably 0.5 to 1.0 mm thick. The sheath has a hardness of preferably 25 to 80 Shore A, more preferably 30 to 60 Shore A, and most preferably 40 to 55 Shore A. The personal care products can be, for example, a toothbrush or a razor.

Another aspect of the invention includes forming a toothbrush handle and sandwich molding onto the toothbrush handle a grip in which the grip comprises a core and a sheath surrounding the core and the sheath having a hardness greater than the core.

Still another aspect of the invention includes forming a razor handle and sandwich molding onto the razor handle a grip in which the grip comprises a core and a sheath surrounding the core and the sheath having a hardness greater than the core.

A further invention includes applying a grip to the handle of a personal care product in which the grip comprises a core and a sheath surrounding the core.

Another aspect of the invention includes applying a grip to the handle of a personal care product wherein the grip comprises a first layer and a second outer layer surrounding the first layer and forming a hollow core within the first layer. The hollow core can be made by injecting a gas into the middle of the first layer.

The invention also features products made by the above described methods. One product includes a toothbrush including a toothbrush handle and a grip formed on the toothbrush handle, the grip having a core and a sheath surrounding the core. In a preferred embodiment, the sheath has a hardness greater than the core. Another product includes a razor including a razor handle and a grip formed on the razor handle, the grip having a core and a sheath surrounding the core. In a preferred embodiment, the sheath has a hardness greater than the core.

The details of one or more embodiments of the invention are set forth in the accompanying drawings and the description below. Other features, and advantages of the invention will be apparent from the description and drawings, and from the claims.

### DESCRIPTION OF DRAWINGS

FIG. 1 is a perspective view of a toothbrush.

FIG. 2 is a cross-sectional view of the toothbrush of FIG. 1.

FIG. 2A is a close up of a portion of the toothbrush of FIG. 2.

FIG. 3 is a cross-sectional view taken along line 3-3 of the toothbrush of FIG. 2.

FIG. 4 is a perspective view of the toothbrush of FIG. 1 without the grips.

FIG. 5 is a cross-sectional view of a mold used to overmold the grips onto the toothbrush of FIG. 4 with a toothbrush handle in the mold cavity.

FIG. 6 is a cross-sectional view of the mold of FIG. 5 with a shot of sheath material entering the cavity.

FIG. 7 is a cross-sectional view of the mold of FIG. 6 with a shot of core material entering the cavity.

FIG. 8 is a cross-sectional view of the mold of FIG. 7 with a final shot of sheath material entering the cavity.

FIG. 9 is a cross-sectional view of a toothbrush with hollow grips.

### DETAILED DESCRIPTION

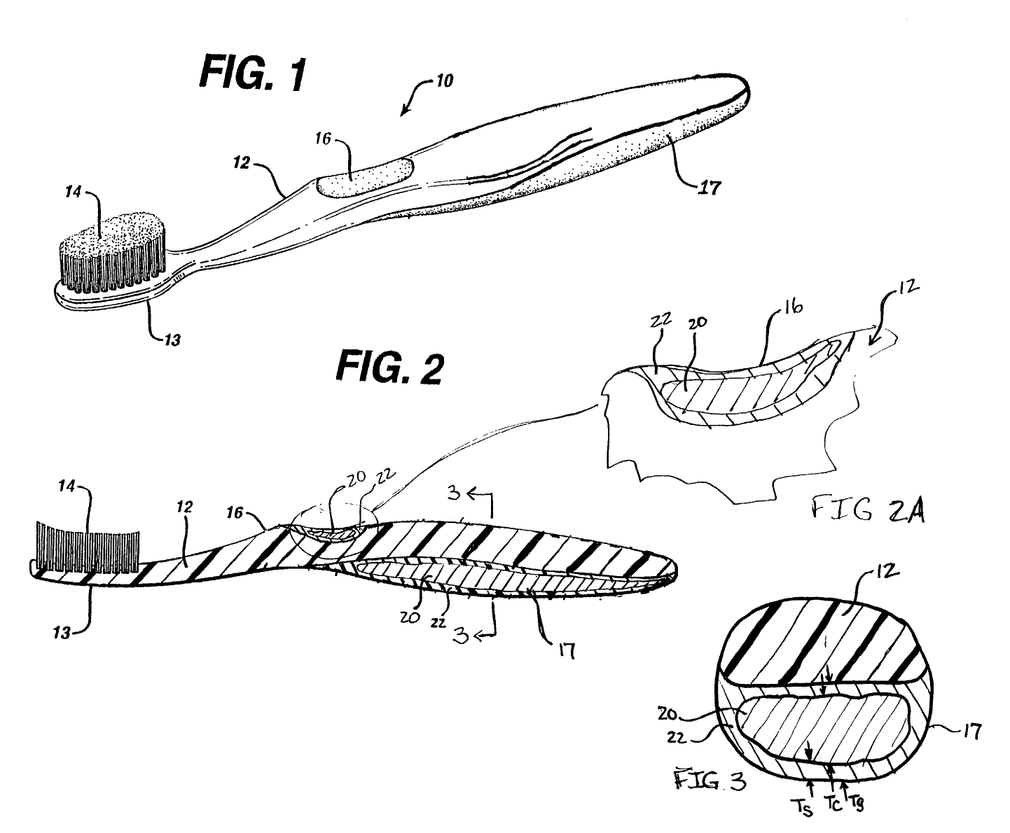

Referring to FIG. 1, a toothbrush 10 includes a handle 12 and a head portion 13. Bristles 14 are mounted on the head 13. The handle 12 includes grips 16 and 17. The grips 16,17 provide comfort for the user and a non-slip surface to prevent the handle from slipping from the user's grip.

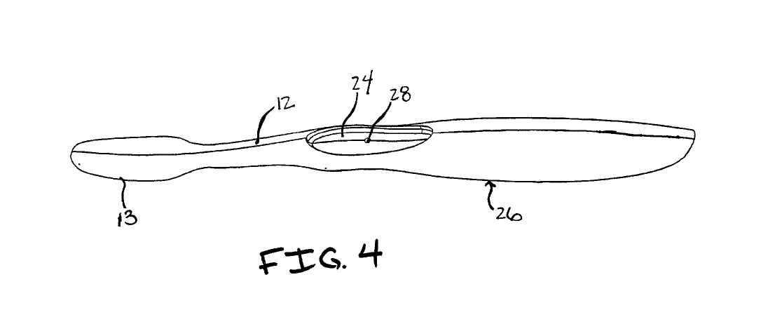

Referring to FIGS. 2 and 3, the grips 16, 17 include a core 20 enclosed in a sheath 22. Both the core 20 and the sheath 22 are generally formed of elastomeric materials, such as thermoplastic elastomers.

The core 20 and sheath 22 will be formed such that the sheath is a thin layer around the core. For example on grip 17, the sheath at its thinnest point, Ts, is preferably 0.4 to 4.0 mm thick, more preferably 0.5 to 2.0 mm thick, and most preferably 0.5 to 1.0 mm thick. By varying the thickness of the sheath, the hardness of the grip, and thus the way it feels to a user, can be adjusted. However, in most cases, a minimal sheath thickness is desirable. The thickness of the core will be dependent on the toothbrush design and size and the material used for the sheath. For example, for a typical Oral-B adult Cross Action™ toothbrush, the core at its thickest point, Tc, will be 2.0 to 7.0 mm thick, more preferably 4.0 to 7.0 mm, and most preferably 6.0 to 7.0 mm. The overall thickness of the grip 17 at its thickest point, Tg, would be approximately 8.0 to 9.0 mm thick.

The core 20 is formed of a relatively softer thermoplastic elastomer than the sheath 22. The core material has a hardness of less than 50 Shore A, more preferably less than 25 Shore A, and most preferably less than 10 Shore A. The sheath material has a hardness of from 25 to 80 Shore A, more preferably 30 to 60 Shore A, and most preferably 40 to 55 Shore A. The combination of core and sheath hardness will depend on the design and desired feel of the toothbrush.

A preferred sheath material is commercially available under the tradename Dynaflex GLS G6735, which is a thermoplastic elastomer, and more specifically a styrenic block-copolymer (styrene-ethylene-butylene-styrene). This material has a hardness of 35 Shore A. A preferred core material is commercially available under the tradename Dynaflex GLS G6703, which is also a styrenic block-copolymer. This material has a hardness of 3 Shore A. The resultant sandwich molded grip has a hardness of 12 Shore A with a sheath thickness of 1 mm.

Another possible combination includes a thermoplastic elastomer sheath material called Kraiburg HTF 7849/76, which has a hardness of 53 Shore A, and a core material of Dynaflex G6703 with a hardness of 3 Shore A. The resultant sandwich molded grip has an overall hardness of 18 Shore A with a sheath thickness of 1 mm.

Other classes of thermoplastic elastomers can be used in producing the sandwich molded grips, such as thermoplastic vulcanates (rubber polyolefin blends), polyetheramides, polyesters, styrene-ethylene-butylene-styrene (SEBS) block copolymers, styrene-butadiene-styrene (SBS) block copolymers, partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof. Other suitable materials include closed cell foams, resilient urethanes and silicones.

An example experiment with a preferred sheath/core combination included the Dynaflex GLS G6735 sheath material and Dynaflex GLS G6703 core material described above. The grip was molded onto an Oral-B™ adult-sized toothbrush handle. The mold temperature was maintained at 30° C. The sheath material was heated to 200° C., and the core material to 190° C. Varying amounts of sheath material were injected to determine the minimum thickness of the sheath attainable. A ratio of 45% sheath material to 55% core material produced the thinnest sheath possible without having the core material break through. The resultant grip had a sheath thickness of approximately 1.0 mm at the grip's widest point, a core thickness of approximately 5.5 mm and overall hardness of 12 Shore A.

When choosing the sheath and core materials for a particular application, several physical parameters should be considered. First, the two materials preferably have similar melt temperatures. If the process melt temperatures of the two materials are very different, the material with the lower melt temperature might not be able to stand the higher processing temperature without degradation.

Second, the melt viscosities of the two materials at process temperature can be similar or different. However, the viscosity of the sheath material at process temperature generally should not be less than 45% of the viscosity of the core material at process temperature. The lower the sheath material viscosity relative to the core material viscosity, the more likely it is that the core will break through the sheath or cause swirl marks in the sheath from mixed sheath and core materials. However, in applications where swirl marks may be aesthetically desirable, the sheath material can be chosen with a viscosity less than 45% below that of the core material to produce the swirl marks.

Finally, the sheath material is chosen to adhere to the substrate on which the grip is overmolded. It is also desirable to have the sheath adhere to the core material.

The handle 12 is generally formed of a thermoplastic material, such as polypropylene, polyurethane or acrylonitrile butadiene styrene. The toothbrush 10 can be made by first forming the toothbrush handle 12 by conventional injection molding techniques. Handle 12 can also be made by sandwich-molding two materials, such as a clear sheath with a colored core.

As shown in FIG. 4, the handle is formed with grip areas 24, 26 onto which grips 16, 17 will be overmolded. The grip areas 24, 26 are generally recessed and shaped like the final grip shape. However, the grip areas can simply be areas on the handle of less material, and not an actual recess; that is, not a recess with defined walls as shown in FIG. 4. Further, a hole 28 can be formed through the handle, connecting the grip areas 24, 26 that are located on opposite sides of the handle.

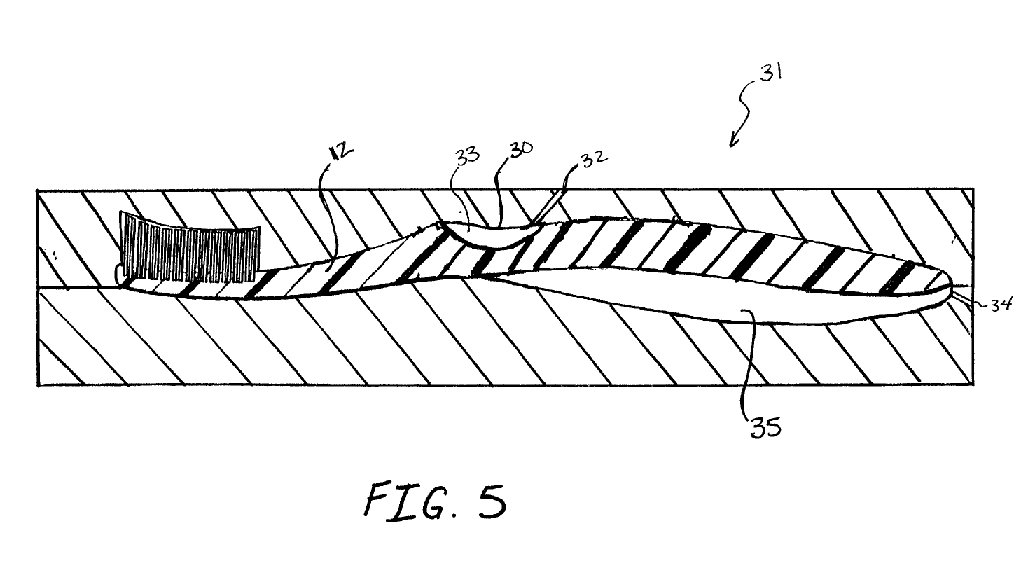

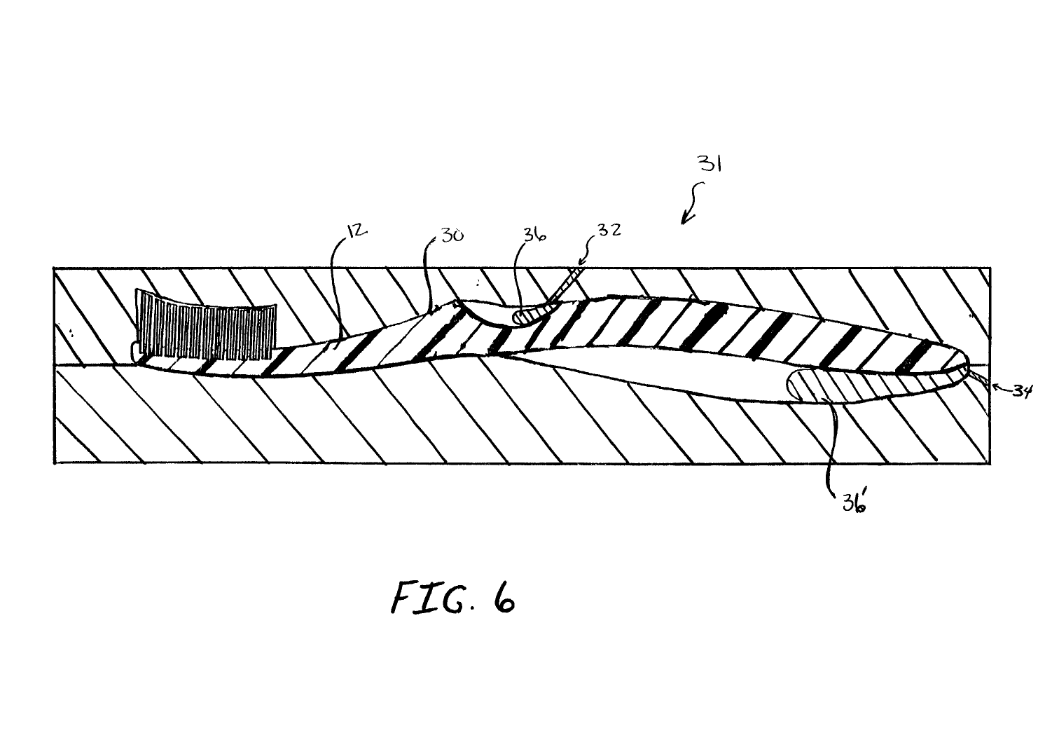

Referring to FIGS. 5-8, the grips 16, 17 may be formed by a sandwich-molding process. First, as shown in FIG. 5, the handle 12 is placed into a mold cavity 30. The mold cavity has gates 32, 34 to inject the elastomeric materials to form the sandwich-molded grips. A shot of sheath material 36 is injected into the gates to start forming the sheath 22 of the grips 16, 17, as shown in FIG. 6. The amount of sheath material injected is calculated to provide a sheath with the desired thickness when the core material is subsequently injected into the sheath material. A minimum thickness is necessary to prevent the core material from breaking through the sheath. For example, a minimum of approximately 45% by volume of sheath material is generally suitable to prevent break-through when using the Dynaflex polymers, discussed in the example above. As is common with sandwich-molding techniques, as the melted sheath material enters the mold cavity, it comes into contact with the cooled walls of the mold cavity and begins to cool, thereby increasing its viscosity.

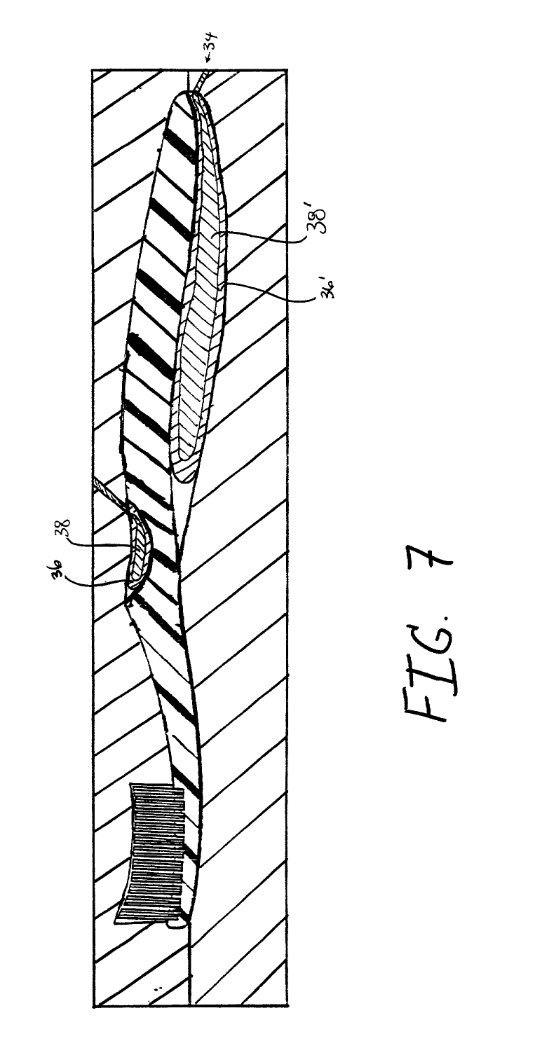

A shot of core material 38 is then injected into the center of the sheath material 36 through the same gates 32, 34, thereby filling and expanding the sheath material to the shape of the mold (FIG. 7). A sufficient amount will be injected to expand the sheath material and almost fill the mold cavity defining the grip, leaving room for a final shot of sheath material, which will seal the gate area and cover the core material. However, care should be taken not to inject an amount of core material 38 that would completely fill the mold cavity and possibly break through the sheath.

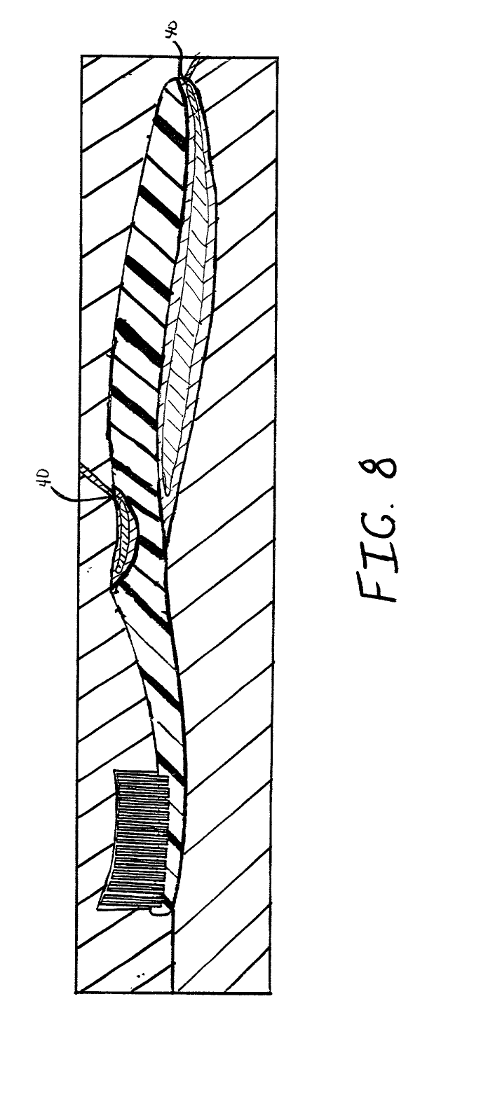

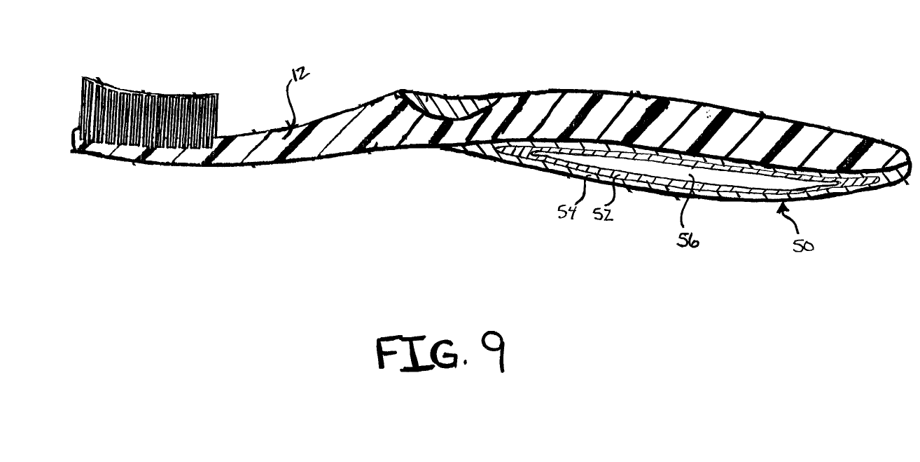

Finally, a small shot of sheath material 40 is injected through the gates to seal off the core material (FIG. 8). The final shot of sheath material 40 gives the finished grip a clean look. If the final shot of sheath material is not injected, a small amount of the core material 38 will poke through the sheath at the gate location. However, sealing the gate area with sheath material may not be necessary if the gate is small enough or is in a non-visible area of the molded part.

A number of embodiments of the invention have been described. Nevertheless, it will be understood that various modifications may be made without departing from the spirit and scope of the invention. For example, core 20 may be a powder, liquid or gas. Also, gas-assisted or fluid-assisted molding combined with sandwich-molding can be used to create a hollow grip with a dual layer skin 50. Two materials can be sandwich-molded, and then air, or other fluid such as water, can be injected into the middle of the core 52 to create a hollow space 56, as shown in FIG. 9. The core 52 will expand with the sheath 54, creating a dual layer skin 50.

Further, clear or opaque materials can be used for the sheath or core materials. Also, fillers can be added to modify the properties and feel of the finished grip or simply for aesthetic purposes. For example, the core can be combined with a glitter-type filler, and a clear sheath will allow the user to see the core sparkle. Also, additives can be added to the core to facilitate manufacturing. For example, a foaming agent can be added to the core to reduce sink marks in the sheath and/or to reduce cycle time when molding the grip.

Moreover, the sandwich-molded grips of the present invention can be applied to other personal care products, such as razor or hairbrush handles, or to handles of handheld appliances, such as handheld mixers.

Further, if desired, grip 16 may be formed of a single elastomeric material, while grip 17 is made from two elastomeric materials as described above. Also, while the mold depicted includes two gates, a mold with one gate, or any number of gates necessary, may be employed. Accordingly, other embodiments are within the scope of the following claims.

What is claimed is:

1. A method of manufacturing a personal care product comprising:
Applying a grip to a handle of a personal care product, the grip comprising a core and a sheath surrounding the core, the sheath having a hardness greater than the core.

2. The method of claim 1 wherein the core is an elastomeric material.

3. The method of claim 2 wherein the elastomeric material is a thermoplastic elastomer.

4. The method of claim 3 wherein the thermoplastic elastomer is selected from the group consisting of thermoplastic vulcanates (rubber polyolefin blends), polyetheramides, polyesters, styrene-ethylene-butylene-styrene (SEBS) block copolymers, styrene-butadiene-styrene (SBS) block copolymers, partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof.

5. The method of claim 1 wherein the core has a hardness of less than 50 Shore A.

6. The method of claim 5 wherein the core has a hardness of less than 25 Shore A.

7. The method of claim 6 wherein the core has a hardness of less than 10 Shore A.

8. The method of claim 1 wherein the sheath is an elastomeric material.

9. The method of claim 8 wherein the elastomeric material is a thermoplastic elastomer.

10. The method of claim 9 wherein the thermoplastic elastomer is selected from the group consisting of thermoplastic vulcanates (rubber polyolefin blends), polyetheramides, polyesters, styrene-ethylene-butylene-styrene (SEBS) block copolymers, styrene-butadiene-styrene (SBS) block copolymers, partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof.

11. The method of claim 1 wherein the sheath is approximately 0.4 mm to 4.0 mm thick.

12. The method of claim 11 wherein the sheath is approximately 0.5 mm to 2.0 mm thick.

13. The method of claim 12 wherein the sheath is approximately 0.5 mm to 1.0 mm thick.

14. The method of claim 1 wherein the sheath has a hardness of approximately 25 Shore A to 80 Shore A.

15. The method of claim 14 wherein the sheath has a hardness of approximately 30 Shore A to 60 Shore A.

16. The method of claim 15 wherein the sheath has a hardness of approximately 40 Shore A to 55 Shore A.

17. The method of claim 1 wherein the personal care product is selected from the group consisting of toothbrushes and razors.

18. A method of manufacturing a toothbrush comprising:
(a) forming a toothbrush handle; and
(b) sandwich molding onto the handle a grip comprising a core and a sheath surrounding the core, the sheath having a hardness greater than that of the core.

19. A method of manufacturing a razor comprising:
(c) forming a razor handle; and
(d) sandwich molding onto the handle a grip comprising a core and a sheath surrounding the core, the sheath having a hardness greater than that of the core.

20. A method of manufacturing a personal care product comprising:
applying to a handle of a personal care product a grip comprising a core and a sheath surrounding the core.

21. A personal care product comprising:
(e) a handle; and
(f) a grip formed on the handle, the grip comprising a core and a sheath surrounding the core, the sheath having a hardness greater than the core.

22. The personal care product of claim 21 wherein the core is a elastomeric material.

23. The personal care product of claim 22 wherein the elastomeric material is a thermoplastic elastomer.

24. The personal care product of claim 23 wherein the thermoplastic elastomer is selected from the group consisting of thermoplastic vulcanates (rubber polyolefin blends), polyetheramides, polyesters, styrene-ethylene-butylene-styrene (SEBS) block copolymers, styrene-butadiene-styrene (SBS) block copolymers, partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof.

25. The personal care product of claim 21 wherein the core has a hardness of less than 50 Shore A.

26. The personal care product of claim 25 wherein the core has a hardness of less than 25 Shore A.

27. The personal care product of claim 26 wherein the core has a hardness of less than 10 Shore A.

28. The personal care product of claim 21 wherein the sheath is an elastomeric material.

29. The personal care product of claim 28 wherein the elastomeric material is a thermoplastic elastomer.

30. The personal care product of claim 29 wherein the thermoplastic elastomer is selected from the group consisting of thermoplastic vulcanates (rubber polyolefin blends), polyetheramides, polyesters, styrene-ethylene-butylene-styrene (SEBS) block copolymers, styrene-butadiene-styrene (SBS) block copolymers, partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof.

31. The personal care product of claim 21 wherein the sheath is approximately 0.4 mm to 4.0 mm thick.

32. The personal care product of claim 31 wherein the sheath is approximately 0.5 mm to 2.0 mm thick.

33. The personal care product of claim 32 wherein the sheath is approximately 0.5 mm to 1.0 mm thick.

34. The personal care product of claim 21 wherein the sheath has a hardness of approximately 25 Shore A to 80 Shore A.

35. The personal care product of claim 34 wherein the sheath has a hardness of approximately 30 Shore A to 60 Shore A.

36. The personal care product of claim 35 wherein the sheath has a hardness of approximately 40 Shore A to 55 Shore A.

37. The personal care product of claim 21 wherein the handle is a toothbrush handle.

38. The personal care product of claim 21 wherein the handle is a razor handle.

39. The personal care product of claim 21 wherein the handle is a hairbrush handle.

40. A toothbrush comprising:
(a) a toothbrush handle; and
(b) a grip formed on the handle, the grip comprising a core and a sheath surrounding the core, the sheath having a hardness greater than the core.

41. A razor comprising:
(a) a razor handle; and
(b) a grip formed on the handle, the grip comprising a core and a sheath surrounding the core, the sheath having a hardness greater than the core.

42. A toothbrush comprising:
(a) a handle; and
(b) a grip formed on the handle, the grip comprising a core and a sheath surrounding the core.

43. A razor comprising:
(a) a razor handle; and
(b) a grip formed on the handle, the grip comprising a core and a sheath surrounding the core.

44. A method of manufacturing a personal care product comprising:
(a) applying to a handle of personal care product a grip comprising a first layer, a second outer layer surrounding the first layer; and
(b) forming a hollow core within the first layer by injecting a gas into the middle of the first layer.

45. A personal care product comprising:
(a) a handle, and
(b) a grip formed on the handle, the grip comprising a first layer, a second outer layer surrounding the first layer, and a hollow core within the first layer.

46. The personal care product of claim 21 wherein the core further comprises a foaming agent.

47. A handheld household appliance comprising:
(a) a handle; and
(b) a grip formed on the handle, the grip comprising a core and a sheath surrounding the core.

48. The handheld household appliance of claim 47 wherein the sheath has a hardness greater than the core.
